(19) United States
(12) Patent Application Publication
(10) Pub. No.: US 2008/0186972 A1
(43) Pub. Date: Aug. 7, 2008

(54) Data Stream Synchronization

(75) Inventor: Yangbin Guo, Chengdu (CN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/996,298

(22) PCT Filed: Jul. 28, 2006
(86) PCT No.: PCT/IB06/52595

§ 371 Date: Jan. 23, 2008

(30) Foreign Application Priority Data
Jul. 28, 2006 (IB) PCT/IB2006/052595

(51) Int. Cl. H04L 12/56

(52) U.S. Cl. 370/394; 370/395.1

(57) ABSTRACT

The rate at which a receiving device processes a stream of data packets received from an asynchronous device is synchronized with the rate at which the asynchronous device is transmitting the data packets. The device stores the received data packets in a buffer “memory and processes the data from the buffer memory at a sampling rate determined by a sampling rate controller. The sampling rate is adjusted based on a threshold comparison of a memory fill level pointer to synchronize the rate at which the data is processed with the rate at witch the data is being received from the asynchronous device. By synchronizing the rates, buffer underflow and overflow conditions may be avoided.

The present invention relates generally to signal processing technology, and more particularly, to synchronizing data packet streams in an asynchronous environment.

Isochronous data, such as video and audio signals are streamed at a steady rate to ensure that the video or audio may be presented to the user with the best quality. Significant delays in the processing or delivery of isochronous data results in a choppy video or audio presentation. This diminishes the quality of the video or audio provided to the user and is unacceptable for many applications.

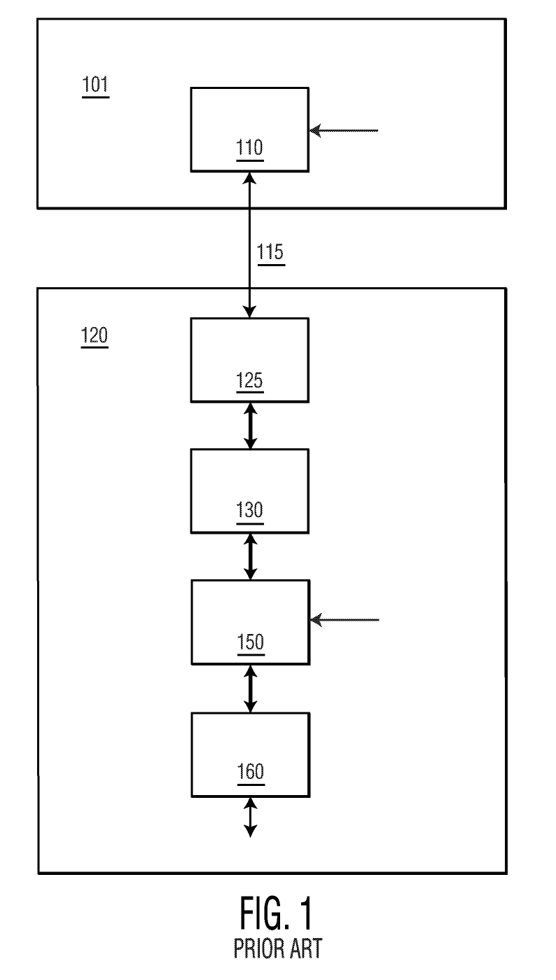

Processing isochronous data becomes even more difficult in real-time asynchronous systems. In an asynchronous system, data may be streamed in packets from a first device to a second device. FIG. 1 illustrates a prior art system 100 for outputting data streams, such as audio or video data, from a computing device 101, such as a personal computer (PC), to an output device 120 over a Universal Serial Bus (USB) connection 115. As illustrated, the computing device 101 includes a host controller 110 which is connected to USB device 120 over a USB connection 115.

In a typical prior art system, the USB device controller of output device 120 receives a stream of data packets transmitted by host controller 110 over USB connection 115. The device controller 125 stores the data packets in a buffer memory 130 until the output device is capable of sampling or otherwise processing the data packets. A sampling interface accesses the data from the buffer memory 130 at a sampling rate based on the output device clock and transfers the data to a digital to analog (D/A) converter 160. The D/A converter converts the digital data into an analog form which is used by the output device to output the data to a user.

The rate at which host controller 110 streams data packets to the output device 120 is determined by CLK1, the clock signal of computing device 101. As discussed above, the sampling rate, or rate at which the output device 120 processes the data received from host controller 110 is determined by CLK2, the output device clock. Due to the asynchronous nature of the system, the rate at which the computing device 110 transmits data packets to the output device 120 may be different than the rate output device 120 processes the data packets.

If the host controller 110 sends data packets at a faster rate than the output device 120 is processing the packets, the buffer memory may fill up. This condition is referred to as a buffer overflow condition. Any data packets that arrive while the buffer memory is full will be dropped. Buffer overflow is unacceptable when dealing with isochronous data such as audio and video because it results in a loss of data that is not output to the user. This condition results in a choppy or incomplete presentation of the audio or video.

If the output device 120 processes the data packets at a faster rate than the host controller 110 is transmitting the data packets, overtime, the buffer memory will be completely empty. The output device will be waiting for the next data packet to arrive for playback to the user. This is referred to as a buffer underflow condition. Buffer underflow is also unacceptable when streaming isochronous data such as audio and video since it will introduce pauses into the audio or video while the output device is waiting for the next data packet.

The same is true in the reverse situation. When audio or video data are being captured by an input device and transmitted to a computing device such as a personal computer, the same problems may occur. If the device is capturing and sending data to the computing device at a rate that is faster than the computing device is processing the data packets, the buffer in the capture device will experience an overflow condition that results in a loss of data. Similarly, if the device is capturing and sending data to the computing device as a rate that is slower than the computing device is processing the data packets, an underflow condition will occur.

The present invention synchronizes the rate at which a receiving device processes a stream of data packets received from an asynchronous device with the rate at which the asynchronous device is transmitting the data packets. In one embodiment, the device stores the received data packets in a buffer memory and processes the data from the buffer memory at a sampling rate determined by a sampling rate controller. The sampling rate may be adjusted to synchronize the rate at which the data is processed with the rate at which the data is being received from the asynchronous device. By synchronizing the rates, buffer underflow and overflow conditions may be avoided.

In one embodiment, the level of the buffer memory may be monitored to determine how to adjust the sampling rate. In one embodiment, the buffer memory comprises a pointer that indicates the level of the buffer memory. This level of the buffer memory may be compared with a threshold position in the buffer memory to determine how the sampling rate may be adjusted. In one embodiment, if the level of the buffer memory is below the threshold, the sampling rate may be decreased to bring the rate at which the device is processing the data packets closer into synchronization with the rate at which the data packets are being transmitted. If the level of the buffer memory is above the threshold position, the sampling rate may be increased. Overtime, the sampling rate will become synchronized with the rate at which the asynchronous device is transmitting the data packets.

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a block diagram of a prior art system for processing data streams in an asynchronous environment.

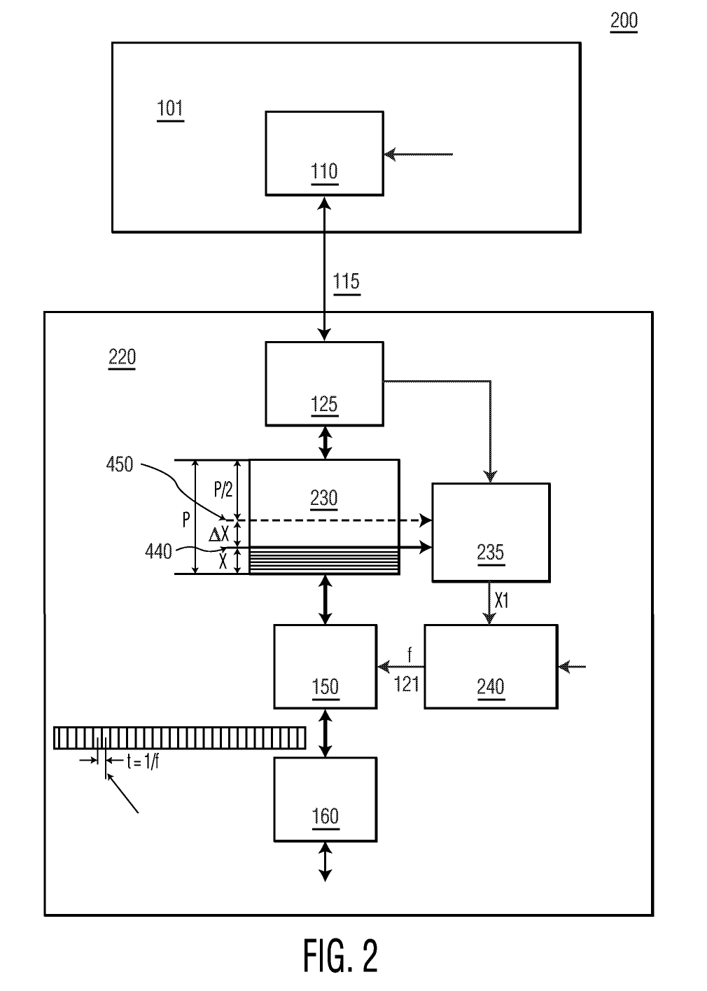

FIG. 2 is a block diagram of a system for synchronizing data streams according to one embodiment of the invention.

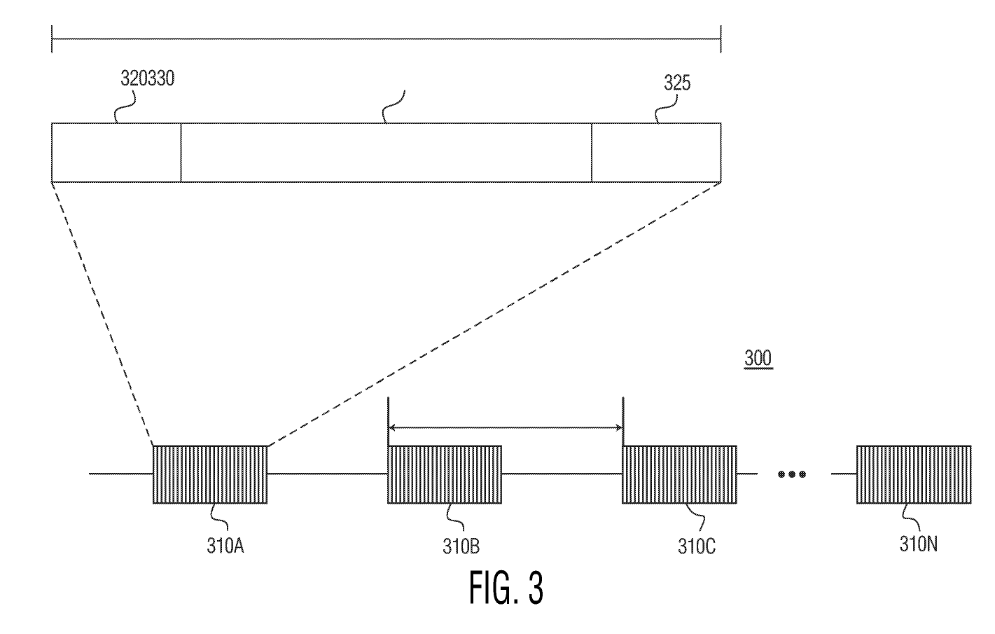

FIG. 3 illustrates a data stream 300 comprising a plurality of data packets 310.

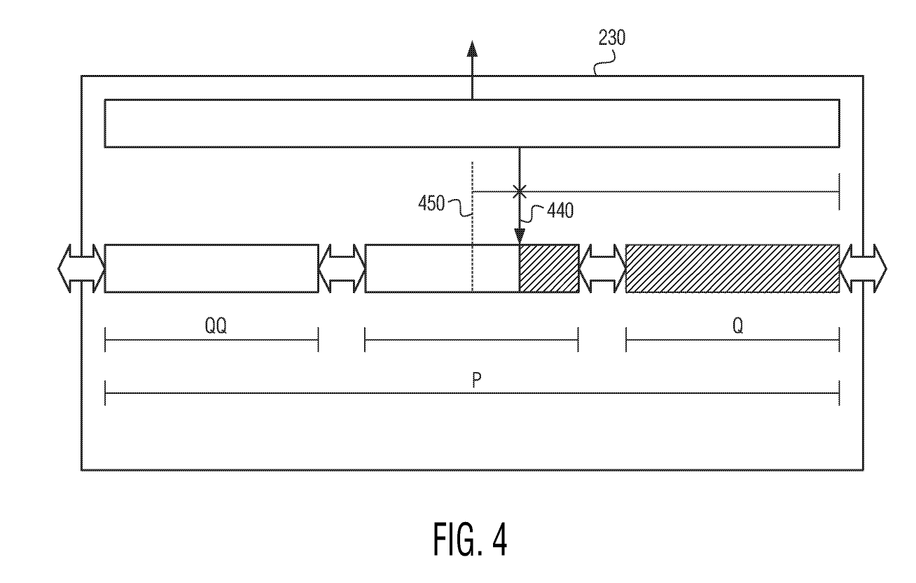

FIG. 4 illustrates an implementation of buffer memory 230 according to one embodiment of the invention.

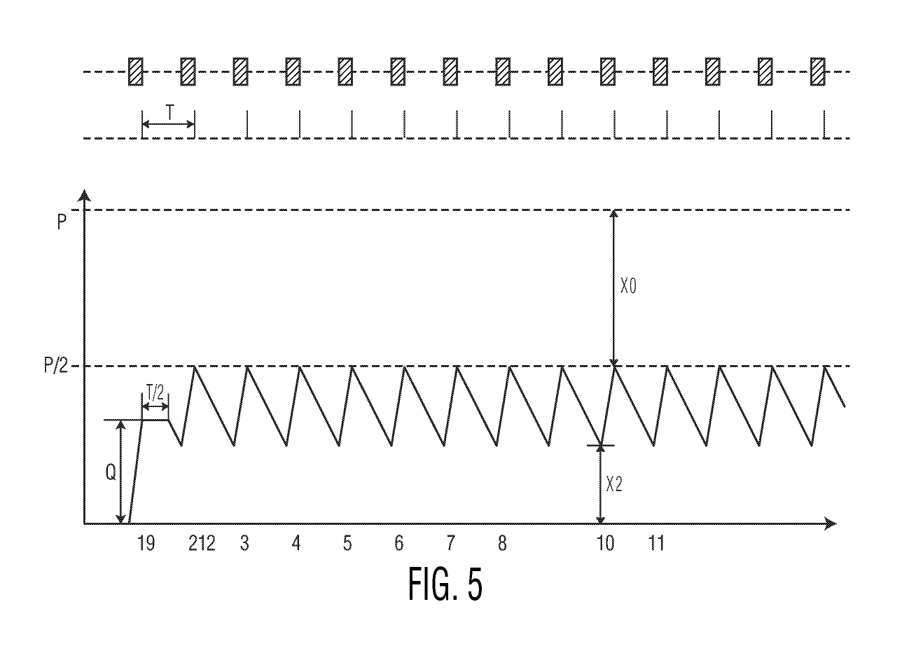

FIG. 5 is a graph illustrating the relationship between a stream of data packets, end of packet (EOP) identifiers and the buffer level in a system in which an output device processes a stream of data packets at the same rate that the host controller is streaming the data packets to the output device.

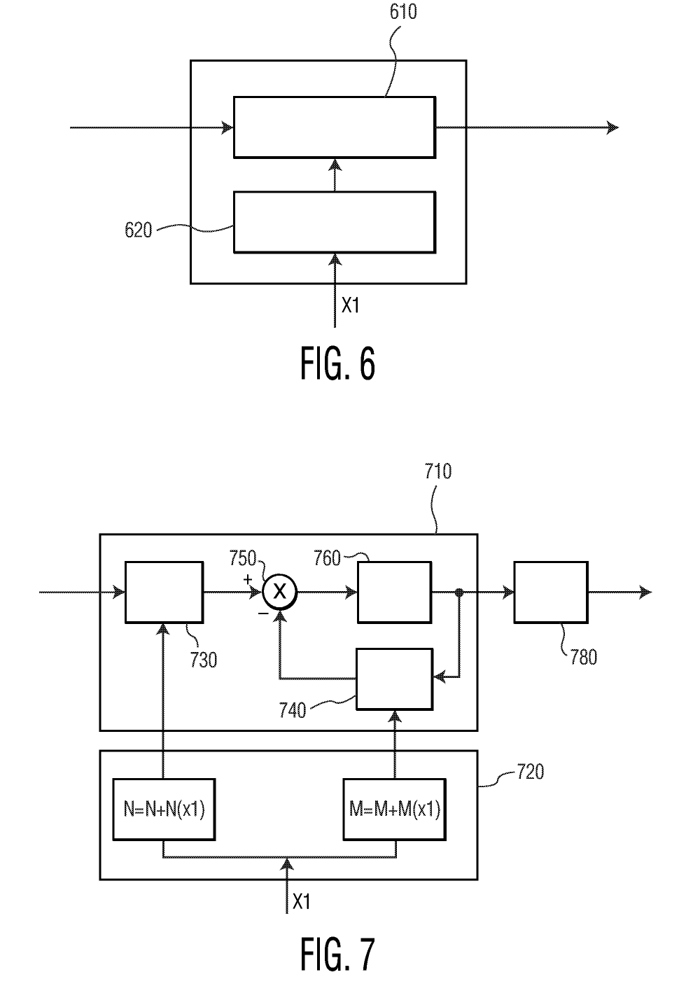

FIG. 6 is a block diagram of a sampling rate controller 240 according to one embodiment of the present invention.

FIG. 7 illustrates a block diagram for adjusting the sampling rate according to one embodiment of the present invention.

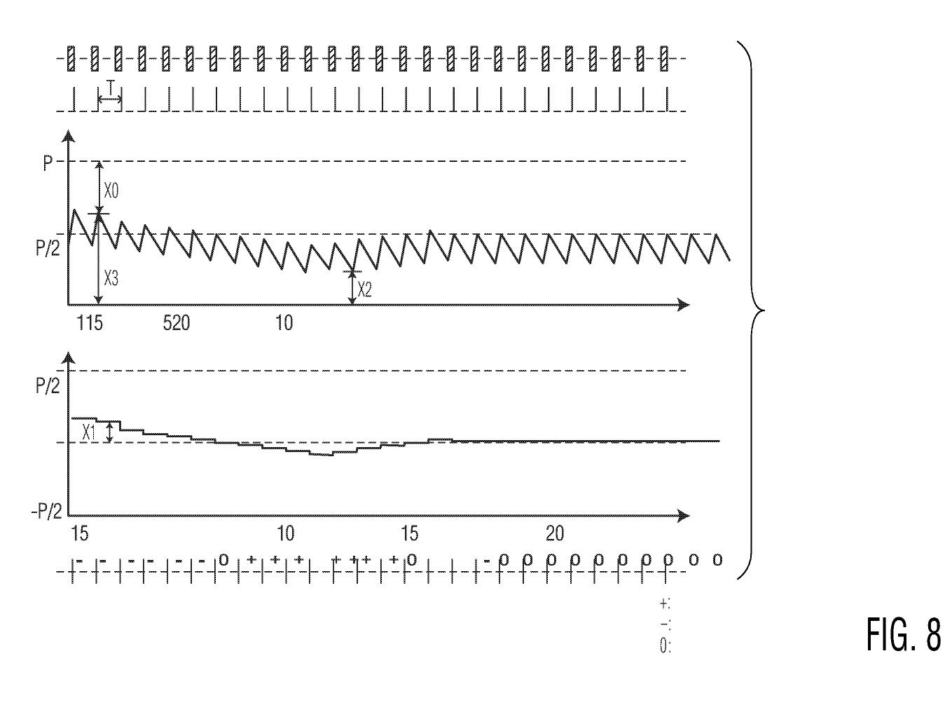

FIG. 8 is a graph illustrating the relationship between the data packets, the end of packet (EOP) identifiers, the buffer memory level, the latched level relative to the threshold and the sampling correction.

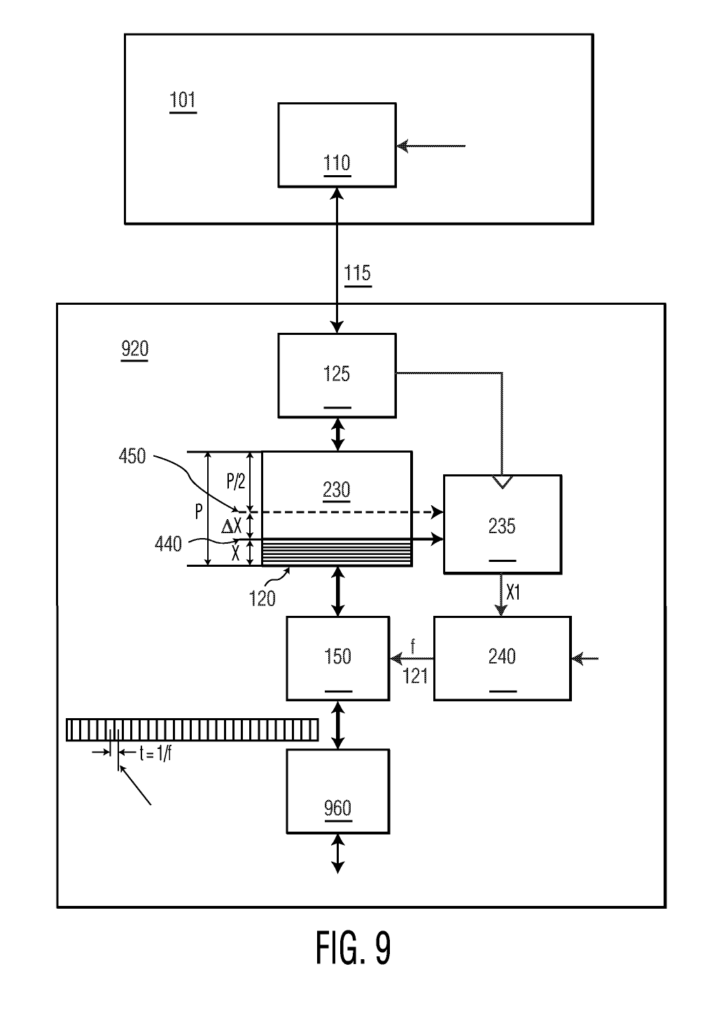

FIG. 9 is a block diagram of a system for synchronizing data streamed from a capture device 920 to a computing device according to one embodiment of the invention.

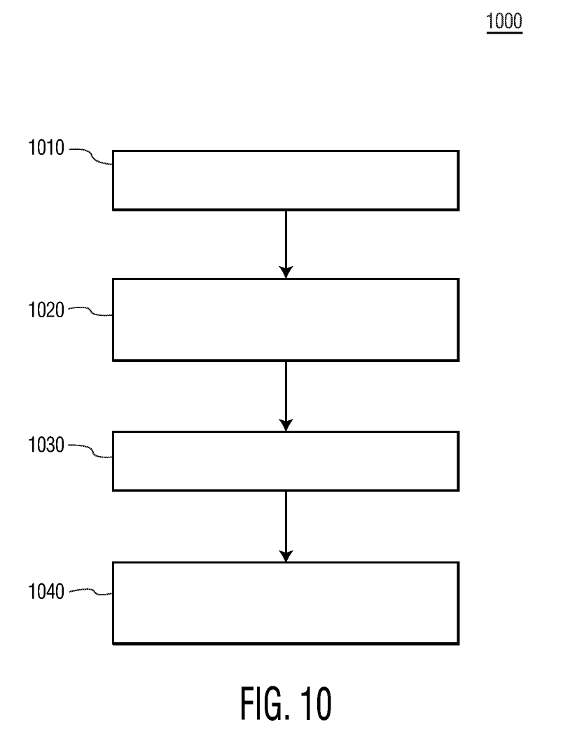

FIG. 10 is a flow chart 1000 for synchronizing a stream of data packets according to one embodiment of the invention.

Systems, apparatuses and methods for synchronizing the rate at which a stream of data packets are processed and transmitted between two asynchronous devices are described. In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Reference in the specification to “one embodiment,” “a preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

FIG. 2 is a block diagram of a data stream synchronization system 200 according to one embodiment of the invention. System 200 includes a USB host controller 110 coupled to output device 220 over a USB connection 115. Output device 220 includes a device controller 125, a buffer memory 230, buffer latch 235, sampling rate controller 240, sampling interface 150 and a digital to analog (D/A) converter 160. Host controller 110, device controller 125, sampling interface 150 and D/A converter 160 are devices that are well known in the art. Buffer memory 230 may be implemented using memory devices that are well known in the art including solid state memory devices. Similarly, buffer latch 235 may be implemented using latches that are well-known in the art, including but not limited to D-latches, SR Flip-Flops and the JK Flip-Flops.

As illustrated, the host controller 110 may be located on a PC or other computing device 101 to stream data packets between the computing device 101 and the output device 220. FIG. 3 illustrates an example of a stream of data packets 300. Stream 300 is comprised of a plurality of data packets 310A-N transmitted at regular intervals, labeled T in FIG. 3. Each data packet 310 may include one of more header fields 320, data 330, and an end of packet (EOP) identifier 325, which signals the end of the data packet.

Output device 220 receives the stream of data packets sequentially at device controller 125, which includes low level hardware for receiving the data packets from the USB connection 115. As the device controller 125 receives each data packet, it stores the data packet in buffer memory 230. The device controller 125 also detects the EOP identifier 325 for each data packet and outputs an EOP signal to buffer latch 335 when the EOP identifier is detected. Sampling interface 150 accesses the data from buffer memory 230 and presents the data to D/A converter 160. The rate at which the sampling interface accesses the packets from the buffer memory 230 is referred to as the sampling rate. In one embodiment, the sampling rate is determined by the sampling rate controller 240 using the output device clock (CLK2) and a buffer offset value as described further herein. The D/A converter 160 converts the digital data retrieved from buffer memory 230 into its analog form for playback by the output device 220.

Note that host controller 110 is controlled by the system clock of the computing device CLK1, while the output device 220 is controller by device clock CLK2. The asynchronous nature of the system means that the rate at which the host controller 110 transmits data packets to output device 220 may differ from the rate at which the output device 220 processes the data packets. If the rate at which host controller streams the data packets is faster than the rate at which output device 220 processes the packets, overtime an overflow condition may occur. If the host controller transmits the data packets at a slower rate than output device 220 processes the data, overtime an underflow condition may occur. As illustrated in FIG. 3, the host controller 110 transmits, or downloads, a data packet to the device controller 125 at regular intervals. In one embodiment, the EOP identifier for each packet may be used to represent the rate at which the host controller is sending data packets to output device 220.

FIG. 4 illustrates an example implementation of buffer memory 230 according to one embodiment of the present invention. In this example, buffer memory 230 is a first-in first-out (FIFO) memory comprising a buffer size equivalent to the size of three data packets. For purposes of this example, assume that each data packet has a size Q as illustrated in FIG. 3. Accordingly, the size, P, of buffer memory 230 is P=3Q. In one embodiment, buffer memory 230 includes a buffer level pointer 440 that points to the level of buffer memory 230. As will be discussed further herein the buffer level pointer 440 may be used as a feedback signal used to adjust the sampling rate to synchronize the rate at which the output device 220 processes the data with the rate at which the host controller 110 is transmitting the data.

In one embodiment, a target pointer 450 may be used as a threshold reference position within buffer memory 230. The target pointer 450 may be defined by the user based on the system requirements to optimize the use of the buffer. In one embodiment, the target pointer identifies a threshold position in buffer memory 230. This threshold position may be the optimal level of the buffer memory 230 when each EOP identifier is received that best prevents an overflow or underflow from occurring.

FIG. 5 illustrates the relationship between a stream of data packets, EOP indicators and the buffer level in a system in which the rate at which the output device processes packets is in sync with the rate the host controller is streaming the data packets to the output device. As illustrated in FIG. 5, the buffer level initially increases until the buffer has been filled to the level Q, which represents the size of a data packet. At this point, the first data packet has been received. In this example, the output device starts to playback the data a duration T/2 after the first data packet has arrived (i.e. T/2 after the first EOP has arrived). As the next data packet in the stream starts to arrive, the buffer memory has approximately X2=Q/2 byes of data in storage and at least 2Q bytes empty in buffer memory 230. The buffer memory 230 continues to fill and empty as illustrated in FIG. 5 as data packets are received and played out by the output device.

Note, that in the synchronized system of FIG. 5, the buffer memory 230 fills to the half way point and then decreases until it reaches a level of x2 and then fills back to the middle of the buffer as the next packet is received. Note also that the point at which the buffer is half full occurs at each occurrence of an EOP identifier. In one embodiment, this is the threshold position in buffer memory 230. As a result, in the example of FIG. 4, the target pointer 450 provides a reference to the center of buffer memory 230. In the embodiment of buffer memory 230 illustrated in FIG. 4, buffer memory 230 fills from right to left in a first-in first-out fashion. If the buffer level pointer 440 is to the right of the target pointer 450, the buffer is less than half full and if the buffer level pointer 440 is to the left of target pointer 450, the buffer is more than half full. Whenever the buffer level pointer level is below or above the threshold position represented by target pointer 450, the sampling rate may be adjusted to bring the sampling rate closer into synchronization with the rate at which the host controller is streaming packets to the output device.

In the embodiment illustrated in FIG. 2, the buffer level pointer 440 and the target pointer 450 may be latched into buffer latch 235 each time the device controller encounters an EOP identifier 225. The buffer level pointer 440 may be compared with the target pointer 450 and a buffer offset value x1, representing the position of buffer level pointer 440 with respect to target pointer 450, may be may be output to sampling rate controller 240. The sampling rate controller 240 may use the buffer offset value x1 to adjust the sampling rate at which packets are processed by the sampling interface 150.

As the sampling rate is adjusted, the level of buffer memory 230 will increase or decrease accordingly. As a result, the level of buffer level pointer 450 will move closer to the threshold of target pointer 450 when the next EOP identifier is received. The sampling rate will continuously be adjusted upon receipt of each EOP identifier until the buffer level pointer 440 falls on the target pointer 450 at each EOP identifier. At this point, the rate at which the output device is processing the data received from the host controller is in sync with the rate the host controller is streaming the data.

FIG. 6 illustrates one embodiment of sampling rate controller 240 according to the present invention. In this embodiment, the sampling rate controller includes a divide counter 610 coupled to a correction function module 620. Divide counters are well known to one skilled in the art. Correction function module 620 may be implemented using hardware, software, firmware or a combination thereof.

In one embodiment, the sampling rate controller receives the buffer offset value x1 from buffer latch 235 and the device clock (CLK2) of the output device 220 as inputs. The device clock (CLK2) is input to divide counter 610 which divides the device clock by an integer value N, decreasing the frequency of the device clock (CLK2) by N. The output clock is the sampling clock which determines the sampling frequency f of sampling interface 150. One skilled in the art will recognize that the value of N may be determined based on a number of factors related to the application, including the desired sampling rate.

In one embodiment of the invention, the correction function module 620 receives buffer offset x1 as an input. Buffer offset x1 is the difference between target pointer 450 (the threshold position) and buffer level pointer 440. If the buffer level pointer 440 is less than the target pointer 450, the value of x1 will be a positive value. By contrast, if the buffer level pointer 450 is greater than the target pointer, value of x1 will be a negative value.

In one embodiment, the value of N may be adjusted according to the formula N(x1), where N(x1) is a function based on the value of x1. One skilled in the art will recognize that there are a number of functions that may be used to adjust the value of N based on the buffer offset value x1 to obtain the desired increase or decrease to the sampling frequency. In one embodiment, N(x1)=N−1 if the value of x1 is negative and N(x1)=N+1 if the value of x1 is positive. These functions increase or decrease the value of N by one depending on the value of x1. If x1=0, the value of N stays the same.

If the value of x1 is positive, the buffer level is less than the threshold pointer in buffer memory 230. This indicates that the output device 220 is processing the data received from host controller 110 at a faster rate than the data packets are being streamed to output device 220. If the rate the data is processed is not adjusted, the output device 220 may reach a stage where it is waiting for the next data packet to play back to the user. If the output device 220 is outputting audio or video, this may cause a delay in the playback of the data, which may be viewed as choppiness to the user. The present invention increases the value of N in this situation to reduce the frequency of the sampling rate. This reduces the rate at which data packets are processed by the output device 220. The value of N may be adjusted each time an EOP is received by device controller 125. Over time, the rate at which data packets are processed may be synchronized with the rate at which the data packets are streamed from host controller 110.

Similarly, if x1 is negative, the buffer level is greater than the threshold pointer in buffer memory 230. By decreasing the value of N, the frequency of the sampling rate is increased, thus increasing the rate at which data is processed by the output device 220. As the value of N adjusts over time, the rate at which data packets are processed by the output device 220 may become synchronized with the rate at which the host controller 110 is streaming the data packets.

FIG. 7 illustrates an alternative embodiment for adjusting the sampling rate according to the present invention. FIG. 7 illustrates a phase locking loop (PLL) 710 for generating the device clock (CLK2) coupled to a correction function module 720 for adjusting the device clock to synchronize the device clock (CLK2) with the rate the host controller 110 is streaming data packets. PLL 710 includes two divide counters, 730 and 740, a phase detector 750 and a digital control oscillator (DCO) 760. In another embodiment, a voltage control oscillator (VCO) could be used in place of DCO 760. The divide counters 730 and 740, phase detector 750 and digital control oscillator 760 are devices that are well known in the art.

In this embodiment, PLL 710 receives an input clock and an adjusted value of N and M as inputs. The input clock fin, is input to divide counter 730. In one embodiment, the input clock fin, is the source clock of the output device 220. Divide counter 730 divides the frequency of the input clock by the input value N, reducing the frequency of the input clock by N. The reduced frequency clock is output to the phase detector 750. Phase detector 750 aligns the reduced frequency clock with a feedback clock signal generated by DCO 760. In this embodiment, divide counter 740 has been inserted in the feedback loop between the DCO 760 and phase detector 750 to increase the frequency of the clock output from phase detector 750. In this embodiment, the clock output from DCO 760 has a frequency equal to M times the frequency of the clock output from divide counter 730.

The embodiment of FIG. 7 results in a device clock (CLK2) output from PLL 710 of CLK2=(fin)*(M/N). As illustrated in FIG. 7, the device clock (CLK2) may be output to divide counter 780 to create the sampling clock which determines the sampling rate of the device. The frequency of the sampling clock f1=CLK2/L, which may be rewritten as f1=(fm*(M/N))/L. The sampling clock may be output to sampling interface 150 to control the sampling rate and thus the rate at which data packets are processed by the output device 220.

The values of M, N, and L may be set by the user or designer based on the needs of the application to provide any desired sampling frequency. For example, suppose the frequency of the input clock, fin =48 MHz and the user would like an initial sampling clock with a frequency f1=12.288NHz, the initial values may be set to M=6144, N=6000 and L=4. This produces a sampling clock with the desired frequency of 12.288 MHz.

The value of M and/or N may be adjusted to change to the frequency of the device clock (CLK2) output from PLL 710. In one embodiment of the invention, the correction function module 720 adjusts the value of M and/or N based on an input buffer offset value x1. In one embodiment, x1 is the difference between the target pointer 450 (threshold position), and buffer level pointer 440. If the buffer level pointer 440 is less than the target pointer 450, the value of x1 will be a positive value. By contrast, if the buffer level pointer 450 is greater than the target pointer, value of x1 will be a negative value.

In one embodiment, the values of M and/or N may be adjusted according to the functions M(x1) and/or N(x1) respectively. In one embodiment, when x1 is positive, N and M may be adjusted according to the functions M(x1)=M−1 and N(x1)=N−1 to reduce the frequency of the device clock (CLK2) and the sampling clock as discussed above. When x1 is negative, M and N may be adjusted according to the functions M(x1)=M+1 and N(x1)=N+1 to increase the frequency of the device clock (CLK2) and the sampling clock. One skilled in the art will recognize that there are a number of functions, M(x1) and N(x1) that may be used to adjust the values of M and N based on the input x1. It should be noted that, M and N may be adjusted independent of each another. For example, in one embodiment, the value of M may be increased for a given buffer offset value x1 while the value of N is decreased and vice versa. Such adjustments will still have a positive or negative impact on the frequency of device clock (CLK2) and the sampling clock.

Returning to the example above, assume that M, N and L have been set to obtain an initial sampling frequency of 12.288 MHz. If the buffer offset value x1 is negative, the values of M and N may be increased by 1 to adjust the frequency of device clock (CLK2) output from PLL 710 and thus the sampling clock. Using the functions for M(x1) and N(x1) described above, the new device clock frequency is CLK2=(48 MHz)*(6145/6001)=49.1518080 MHz. Dividing the device clock by L gives us a sampling clock of f1=(49.1518080 MHz)/4=12.287952 MHz. This small change to the sampling clock frequency decreases the sampling rate of the output device. This small reduction may result in a small increase in the level of buffer memory 230, bringing the buffer level pointer 440 closer to the target pointer 450 when the next EOP identifier arrives.

It should be noted that the embodiments illustrated in FIGS. 6 and 7 are only two methods for increasing or decreasing the sampling rate based on the level of buffer memory 230. One skilled in the art will recognize that other implementations are possible and are considered within the scope of the present invention.

FIG. 8 is a graph illustrating the relationship between the data packets, the end of packet signals, the buffer memory level, the latched level relative to the threshold and the sampling correction. As illustrated, a data packet arrives at each interval T. The interval T represents the rate at which host controller 110 is transmitting the stream of data packets to the output device 220. Note that when each end of packet (EOP) identifier is encountered, the buffer level pointer 440, represented as x3 in FIG. 8, is latched into buffer latch 235. Dashed line 810 represents the threshold value, i.e. target pointer 450.

The buffer offset value x1 represents the difference between the latched value of x3 and the threshold position. When x1 is above the threshold position, the sampling rate is decreased, represented by the negative (−) signs in the correction of the sampling rate portion of the graph. Note that as the sampling rate decreases, the buffer level pointer x3 decreases until it crosses below the threshold. Once this happens, the sampling rate is increased, represented by the plus (+) sign in the sampling correction rate graph. The sampling rate continues to be adjusted until the system reaches a stable condition, which occurs when the buffer level pointer falls on the threshold position at each EOP identifier.

In FIG. 8, the stable condition occurs at the seventeenth data packet. From this point on, the sampling rate is matched to the rate the host controller is transmitting, or downloading, data packets to the output device. In this state, the system is unlikely to experience an underflow or overflow condition with respect to the buffer memory 230. Note, that the correction of the sampling rate portion of the graph has all zeros beyond data packet seventeen. This illustrates that the sampling rate has reached the stable condition and does not need further adjustments. If the host controller alters the rate at which it transmits data packets, the system will again start to adjust the sampling rate until a new sampling rate is determined that matches the data packet rate of the host controller.

The embodiments discussed above describe how the sampling rate is synchronized with the data rate of the host controller 110 when the data flow is from the host controller 110 to the output device 220 for output by the output device 220. FIG. 9 illustrates one embodiment of the present invention for synchronize the sampling rate with the data rate of the host controller when the data flow is from a capture device 920 to the host controller 110. This occurs when the capture device 920 captures data, such as a video or audio recorder.

When uploading data from an audio or video capture device, the host controller 110 initiates a “stream start” command to start the capture process in capture device 920. The analog audio or video data is captured by the capture device 920 and input to an analog to digital (A/D) converter 960 which converts the analog audio or video signal into its corresponding digital representation. The sampling interface 150 may continuously sample the data from the A/D converter 960 and store the data in the buffer memory 230. The rate at which the sampling interface 150 samples the data is determined by sampling rate controller 240.

The buffer memory 230 continues to fill with data until the device controller 125 receives an input token from the host controller 110. Each time the device controller 125 receives an input token, the device controller 125 transmits a data packet from buffer memory 230 to the host controller 110. The device controller 125 also outputs an input token received signal to buffer latch 235. The input token may be used as a representation of the rate at which the host controller 110 is requesting data packets from the capture device 920. Thus, the input token received signal performs the same function as the EOP identifier described in the embodiment of FIG. 2.

If the sampling rate of the input device is greater than the rate at which the host controller is transmitting input tokens, a buffer overflow condition may occur resulting in lost data. Similarly, if the sampling rate of the input device is less than the rate at which the host controller is transmitting input tokens, a buffer underflow condition may occur. If this occurs, there may not be sufficient data in the buffer to send out a data packet when the next input token is received.

The present invention may be used to prevent an overflow or underflow condition from occurring by synchronizing the rate at which input tokens are received from host controller 110 with the rate at which the data is being processed by the capture device 920. In one embodiment, the buffer level pointer 440 may be latched into buffer latch 235 each time an input token received signal is output to the buffer latch 235 as illustrated in FIG. 9. By monitoring the buffer level at the intervals determined by the input tokens and adjusting the sampling rate as discussed above, the sampling rate may be synchronized with the rate at which the host controller 110 is requesting data packets.

FIG. 10 illustrates a flow chart 1000 of a method for adjusting the sampling rate according to the present invention. In step 1010, a stream of data packets is received. In step 1020, each of the data packets within the stream is stored in the buffer memory as it is received. As discussed above, the data packets may be stored sequentially in a first-in first-out (FIFO) memory until the system is ready to process the data packets. As discussed above, the packets are processed by the system according to the sampling rate.

In step 1030, the level of the buffer memory is monitored to determine how much of the buffer memory is filled with data packets from the stream of data packets at a given time. In one embodiment, the level of the buffer memory is monitored when an EOP identifier is received. In step 1040, the sampling rate is adjusted responsive to the level of the buffer memory relative to a threshold position in the buffer memory. In one embodiment, the threshold position may be the middle of the memory buffer. In this embodiment, the sampling rate may be adjusted depending on how full the buffer memory is with respect to the middle of the buffer memory. In another embodiment, the threshold value may be determined by the user.

In one embodiment, the level of the buffer memory may be compared with the threshold position to determine the relationship of the buffer level to the threshold position. If the buffer level is below the threshold, the sampling rate may be decreased to allow the buffer to fill more. Decreasing the sampling rate may bring the sampling rate more into synchronization with the rate that data packets are being sent or requested by the receiving device. If the buffer level is above the threshold, the sampling rate may be increased to decrease the amount of the buffer that is filled with the incoming streamed data packets. Again, decreasing the sampling rate may bring it more into line with the rate at which data packets are being transmitted or requested by the receiving device.

While the present invention has been described with reference to certain embodiments, those skilled in the art will recognize that various modifications may be provided. For example, while the present invention has been described with respect to devices connected over a USB connection, one skilled in the art will recognize that the present invention is not limited to USB devices and may be used in any asynchronous environment in which data streams require or may benefit from synchronization. Examples of other data stream technologies that may benefit from the present invention include, but are not limited to, PCI, Firewire (IEEE 1394), and Voice over IP (VoIP) data streams. Variations upon and modifications to the embodiments are provided for by the present invention, which is limited only by the following claims.

What is claimed is:

1. A system for synchronizing a first rate at which a first device processes data packets received from an asynchronous device with a second rate at which the asynchronous device is transmitting the data packets, comprising: a buffer memory for storing the data packets received from the asynchronous device, the buffer memory comprising a pointer indicating a level of the buffer memory; and a sampling rate controller for adjusting the first rate based on the position of the pointer with respect to a threshold position within the buffer memory, wherein overtime the first rate at which the data packets are processed from the buffer memory is synchronized with the second rate at which the asynchronous device transmits the data packets.

2. The system of claim 1, wherein the sampling rate controller increases the first rate if the pointer is above the threshold position.

3. The system of claim 1, wherein the sampling rate controller decreases the first rate if the pointer is below the threshold position.

4. The system of claim 1, wherein the threshold position is the middle of the buffer memory.

5. The system of claim 1, wherein the threshold position is defined by the user.

6. The system of claim 1, wherein the buffer memory is a first in first out (FIFO) memory device.

7. A method for adjusting a sampling rate for processing a plurality of data packets in a first device to prevent a buffer memory from experiencing an underflow or overflow condition, comprising: receiving a stream of data packets from a second device; storing each of the data packets as it is received in the buffer memory; processing the data packets from the buffer memory at a rate determined by the sampling rate; monitoring a level of the buffer memory; and adjusting the sampling rate based on the level of the buffer memory relative to a threshold position within the buffer memory, wherein overtime, the sampling rate is synchronized with a rate at which the second device streams the data packets to the first device.

8. The method of claim 7 wherein the level of the buffer provides an indication as to how much of the buffer is being used.

9. The method of claim 7 wherein the sampling rate is decreased if the level of the buffer memory is above the threshold position.

10. The method of claim 7 wherein the sampling rate is increased if the level of the buffer memory is below the threshold position.

11. The method of claim 7 wherein the threshold position is the middle of the buffer.

12. A method for adjusting a sampling rate for storing data to a buffer memory in a capture device, comprising: receiving input tokens from a second device; storing data captured by the capture device in a buffer memory wherein the data is stored at a rate determined by the sampling rate; monitoring a level of the buffer memory; and adjusting the sampling rate based on the level of the buffer memory relative to a threshold position within the buffer memory, wherein overtime, the sampling rate is synchronized with a rate at which the second device is transmitting the input tokens.

13. The method of claim 12 wherein the level of the buffer provides an indication as to how much of the buffer is being used.

14. The method of claim 12 wherein the sampling rate is decreased if the level of the buffer memory is above the threshold position.

15. The method of claim 12 wherein the sampling rate is increased if the level of the buffer memory is below the threshold position.

16. The method of claim 12 wherein the threshold position is the middle of the buffer.

17. A sampling rate controller for adjusting a sampling clock based on a level of a buffer memory for storing a stream of data packets, comprising: a divide counter for receiving an input clock and dividing the input clock by a divider to create the sampling clock; and a correction function module for adjusting a value of the divider based on the level of the buffer memory with respect to a threshold position within the buffer memory.

18. The sampling rate controller of claim 17, wherein the value of the divider is increased if the level of the buffer memory is above the threshold position.

19. The sampling rate controller of claim 17, wherein the value of the divider is decreased if the level of the buffer memory is below the threshold position.
